(19) United States
(12) Patent Application Publication
(10) Pub. No.: US 2015/0269533 A1
(43) Pub. Date: Sep. 24, 2015

(54) USING CONTEXTUAL, CONSTRAINT AND PREFERENCE INFORMATION TO OPTIMIZE GROUP ACTIVITIES

(71) Applicants: Sharad K. Garg, Portland, OR (US); Mark D. Yarvis, Portland, OR (US); Joshua Boelter, Portland, OR (US); Hong Li, El Dorado Hills, CA (US)

(72) Inventors: Sharad K. Garg, Portland, OR (US); Mark D. Yarvis, Portland, OR (US); Joshua Boelter, Portland, OR (US); Hong Li, El Dorado Hills, CA (US)

(21) Appl. No.: 14/221,880

(22) Filed: Mar. 21, 2014

(51) Int. Cl. G06Q 10/10

(52) U.S. Cl. CPC G06Q 10/1097

(57) ABSTRACT

Systems and methods may provide for generating a schedule for a plurality of tasks based on one or more of contextual information, constraint information or preference information related to the plurality of tasks, wherein the schedule includes a plurality of individual-specific task lists. Additionally, a real-time change in one or more of the contextual information, the constraint information, current status or the preference information may be detected and the schedule may be automatically revised in response to the real-time change. In one example, at least a portion of the revised schedule is communicated to one or more individuals responsible for completing at least one of the plurality of tasks.

### TECHNICAL FIELD

Embodiments generally relate to optimizing group activities. More particularly, embodiments relate to using contextual, constraint and preference information to optimize group activities.

### BACKGROUND

Conventional devices may include location aware application programming interfaces (APIs) that are able to determine the location of the device and use that location to provide various services to the end user. For example, the end user might manually create a static “To Do” list on the device, wherein the location aware API may notify the user when stores and/or services related to the To Do list are nearby. While such an approach may be suitable under certain circumstances, there remains considerable room for improvement. More particularly, because sequencing of the activities under such an approach is left up to the user to determine manually, there may be instances in which an inefficient sequencing leads to wasted time and/or missed opportunities to complete activities. Additionally, the static nature of the To Do list may render the list irrelevant and/or useless if changes in circumstances arise. Indeed, status changes with regard to other individuals may also impact the To Do list of the user in question (e.g., potentially requiring the end user to manually create another task list). More particularly, one user's To Do list may be impacted by another user's To Do list, status, availability, location and/or last minute changes in the other user's current plan (e.g., getting stuck in traffic or in a meeting longer than expected).

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a dynamic optimization system according to an embodiment;

FIG. 2 is a block diagram of an example of a schedule revision according to an embodiment;

FIG. 3 is a flowchart of an example of a method of optimizing schedules in response to real-time changes according to an embodiment;

FIG. 4 is a block diagram of an example of a logic architecture according to an embodiment;

FIG. 5 is a block diagram of an example of a processor according to an embodiment; and

FIG. 6 is a block diagram of an example of a system according to an embodiment.

### DESCRIPTION OF EMBODIMENTS

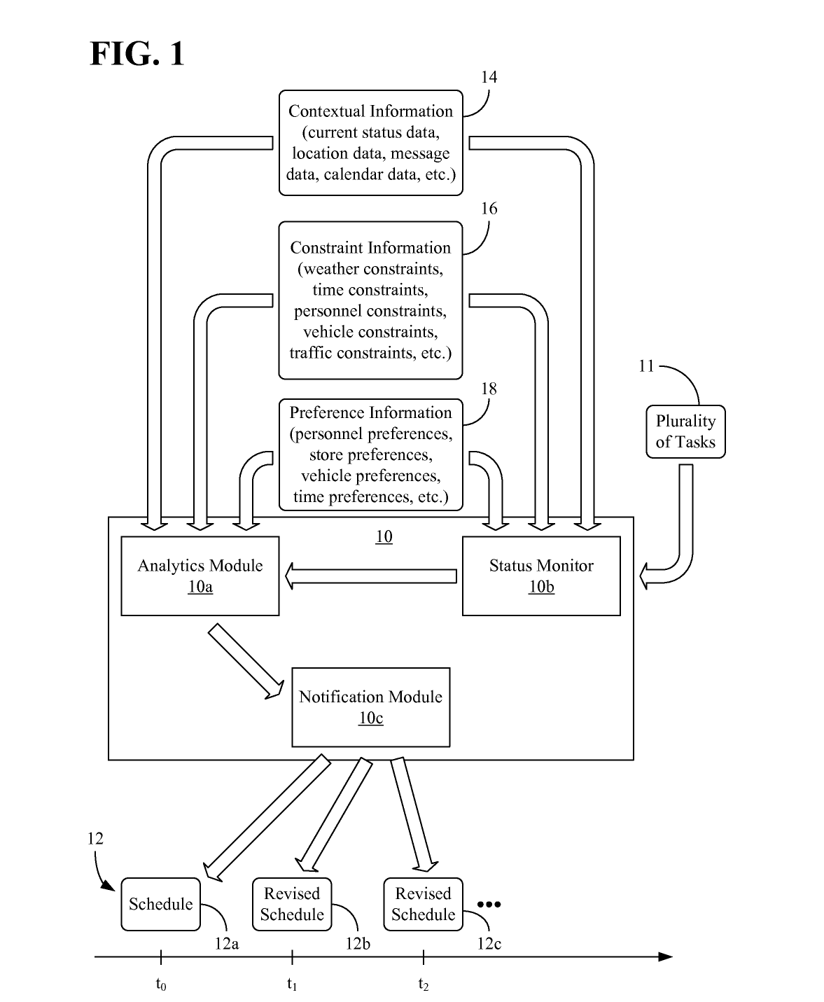

Turning now to FIG. 1, a dynamic optimization system 10 (10a-10c) is shown in which the optimization system 10 includes an analytics module 10a that generates a schedule 12 (12a-12c) for a plurality of tasks 11 based on one or more of contextual information 14 (e.g., current status data, location data, message data, calendar data), constraint information 16 (weather constraints, time constraints, personnel constraints, vehicle constraints, traffic constraints) or preference information 18 (personnel preferences, store preferences, vehicle preferences, time preferences). The schedule 12 may include a plurality of individual-specific task lists, and may therefore be considered a group/collective schedule that enables multiple people (e.g., individuals, users, family members, co-workers) to manage their activities relative to one another.

For example, a first individual (e.g., Adam) may be responsible for completing a first task list in the schedule 12, and a second individual (e.g., Betty) might be responsible for completing a second task list in the schedule 12, wherein the first and second individuals may be related to one another in some respect (e.g., family members, co-workers, friends, etc) so that they are collectively responsible for completing the plurality of tasks 11. As will be discussed in greater detail, the schedule 12 may be dynamically revised over time (e.g., at times t₀, t₁, t₂, etc.) as real-time changes are detected in the contextual information 14, constraint information 16 and/or preference information 18 (e.g., triggered by changes in real-time conditions, periodically, etc.). As a result, the illustrated optimization system 10 may enable the individuals responsible for completing the plurality of tasks 11 to save a considerable amount of time and/or enjoy an enhanced user experience.

More particularly, the illustrated system 10 also includes a status monitor 10b to detect the real-time changes in the contextual information 14, constraint information 16 and/or preference information, with respect to a group of individuals. For example, to the extent that the contextual information 14 includes current status data for one or more individuals, the status monitor 10b may determine whether, for example, the individuals are late and/or behind schedule due to a meeting running over, stuck in traffic, etc.

To the extent that the contextual information 14 includes location data, the status monitor 10b may determine the geographic location (e.g., Global Positioning System/GPS coordinates, address, etc.) of each individual responsible for completing at least one of the plurality of tasks 11. Thus, a change in geographic location (e.g., Betty deviates from her predicted path and enters a store related to a task/activity on Adam's list) may represent an opportunity to further optimize and/or revise an original schedule 12a in response to the real-time change. In such a case, the analytics module 10a may identify the conflict/opportunity and generate a revised schedule 12b that removes the item from Adam's task list and adds it to Betty's list. The revised schedule 12b may be communicated (e.g., via message and/or calendar entry) to the relevant individuals (e.g., Adam and Betty) by a notification module 10c.

In another example, to the extent that the contextual information 14 includes message data (e.g., emails, text messages, instant messages/IMs, voicemail messages/VMs, short messaging system/SMS messages, alerts), the analytics module 10a may interpret the message data to identify opportunities to further optimize and/or revise the original schedule 12a (e.g., a text message to Adam instructing him to pick up medication for his son) in response to the message data. In such a case, the revised schedule 12b generated by the analytics module 10a may include an additional item on, for example, Adam's list, along with an item being moved from Adam's list to Betty's list if Adam no longer has time to complete all of the items on his list. Interpretation of the message data may involve natural language processing (NLP), speech to text processing, and so forth.

To the extent that the contextual information 14 includes calendar data, the status monitor 10b may determine, for example, that someone in the group has accepted a meeting invitation. In such a case, if the analytics module 10a determines that the individual accepting the meeting invitation can no longer follow the original schedule 12a, the revised schedule 12b may be configured to revise the order of one or more individual-specific task lists of the schedule 12, add a task/item to one or more individual-specific task lists of the schedule 12 and/or remove a task/item from one or more individual-specific task lists of the schedule 12, in response to the calendar data change. The contextual information 14 may be obtained from client devices carried by the members of the group, a centralized repository, one or more sensors, user preferences, public information (e.g., the Internet), private information (e.g., a database or intranet), and so forth. Moreover, the contextual information 14 may be obtained periodically (e.g., polled), in response to a trigger, etc., or any combination thereof.

The constraint information 16 may also be used to generate and revise the schedule 12. For example, weather constraints may indicate that one or more tasks are not permitted to be performed in a certain type of weather (e.g., no car wash when it is raining), time constraints may indicate that one or more tasks are not permitted to be performed during certain times of day (e.g., not after business hours), and personnel constraints may indicate that certain individuals are not permitted to perform one or more tasks (e.g., the teenage daughter cannot withdraw cash from the parent's bank account). Similarly, vehicle constraints may indicate that certain vehicles are not permitted to be used to perform one or more tasks (e.g., don't use the sedan to pick up lumber), traffic constraints may indicate that one or more tasks are not possible due to traffic conditions (e.g., during rush hour, it is not possible to drop off child at dance lesson, go to grocery store, and make it back in time for pickup), and so forth. One or more rules giving rise to the constraint information 16 may be predefined and maybe updated for the entire group, on an individual-by-individual basis, etc., or any combination thereof. Another constraint may be a sequencing constraint that a certain task must be completed before completing another task (e.g., buy tennis balls before dropping son off at a tennis game).

Thus, the status monitor 10b may dynamically detect conditions (e.g., weather, natural disasters, time, personnel availability, vehicle availability, traffic) related to the constraint information 16 and notify the analytics module 10a accordingly. In addition, the status monitor 10b may also detect or be notified of an individual's current status dynamically (e.g., Adam is stuck in a meeting, and will be late to drop off his son). The analytics module 10a may in turn generate, for example, a revised schedule 12c, wherein the illustrated notification module 10c notifies the relevant individuals responsible for completing at least one of the plurality of tasks 11 of the revised schedule 12c. The revised schedule 12c may therefore postpone/delay a car wash if it is raining, move a task up in priority if it is to be completed during business hours and the current time is 4:45 PM, and so forth.

The preference information 18 may also be used to generate and revise the schedule 12. For example, personnel preferences may indicate that certain individuals (e.g., Dad) are a primary choice to perform one or more tasks, store preferences may indicate that certain “favorite” grocery stores, pharmacies, cleaners, etc., are a primary choice to be used to perform one or more tasks, vehicle preferences may indicate that certain vehicles (e.g. sports utility vehicle/SUV) are a primary choice to be used to perform one or more tasks, time preferences may indicate a primary choice of a time of day during which one or more tasks are to be performed, and so forth. The preference information 18 may be predefined for the entire group, on an individual-by-individual basis, etc., or any combination thereof.

The modules and/or components of the optimization system 10 may be implemented on a centralized basis, a distributed basis, or any combination thereof. For example, portions of the analytics monitor 10a, status monitor 10b and/or notification module 10c may be implemented as a client-side agent running on an end user device such as, for example, a desktop computer, notebook computer, tablet computer, convertible tablet, smart phone, personal digital assistant (PDA), mobile Internet device (MID), media player, wearable computer, navigation system, etc., whereas other portions of the analytics monitor 10a, status monitor 10b and/or notification module 10c may be implemented in a cloud computing infrastructure (e.g., as a cloud service, on a cloud server) or other network component, as appropriate.

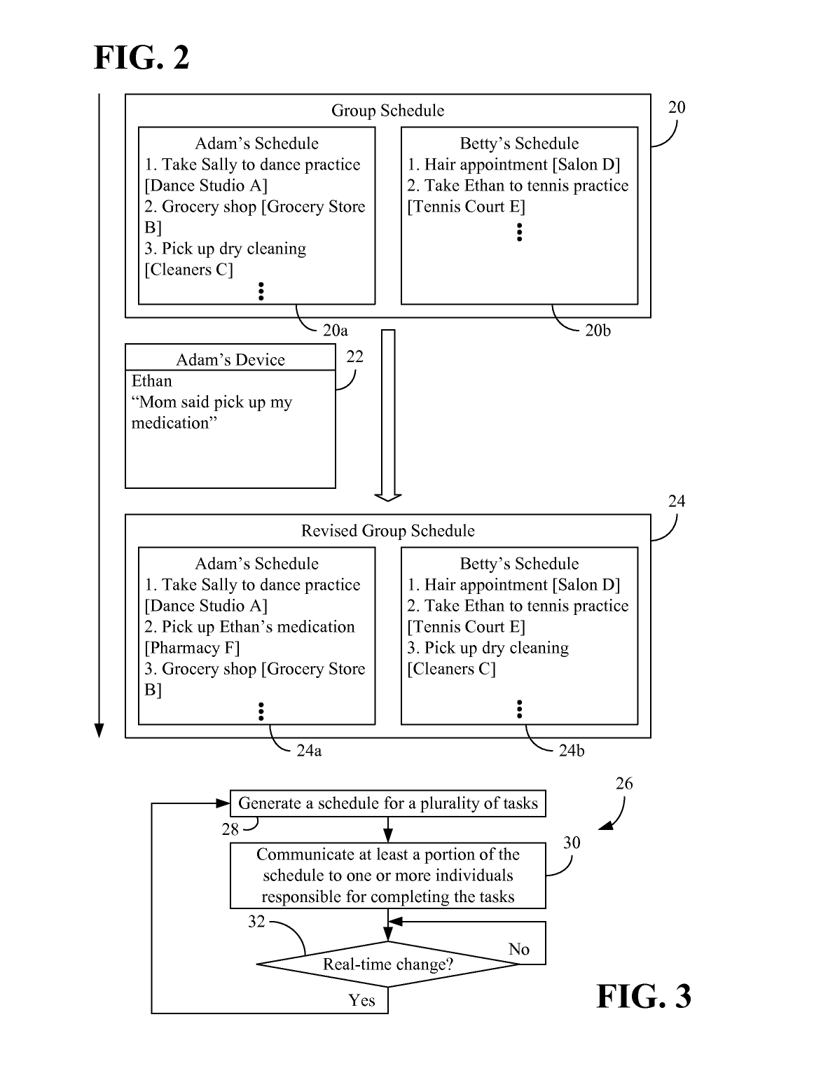

FIG. 2 shows a more detailed example of a schedule revision in which an original schedule 20 (20a, 20b) for a group of individuals (e.g., a “Group Schedule”) includes a plurality of individual-specific task lists. More particularly, a first task list 20a (“Adam's Schedule”) may be associated with a first individual (Adam) and a second task list 20b (“Betty's Schedule”) may be associated with a second individual (Betty), and so forth. In the illustrated example, a message 22 is received on the device of the individual associated with the first task list 20a. As already noted, the message 22 may be interpreted in real-time and used to generate a revised schedule 24 (24a, 24b) that is optimized based on the real-time change represented by the message 22.

For example, it may be determined that first individual cannot complete all of the tasks on the original first task list 20a, given the new responsibility for picking up Ethan's medication. Accordingly, a new task (e.g., “Pick up Ethan's medication [Pharmacy F]”) may be created and added to a revised first task list 24a for the first individual, wherein another task (e.g., “Pick up dry cleaning [Cleaners C]”) may be moved from the original first task list 20a to a revised second task list 24b for the second individual in order to balance out the schedules and take into consideration the capabilities of the individuals responsible for completing the tasks. Other conflicts and/or events such as, for example, skipped tasks or an individual running late, may also be identified and used to dynamically adapt the collective schedule to the change in circumstances. The tasks provided herein are to facilitate discussion only and may vary depending upon the circumstances.

Turning now to FIG. 3, a method 26 of optimizing schedules is shown. The method 26 may be implemented as a module, monitor or related component in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in method 26 may be written in any combination of one or more programming languages, including an object oriented programming language such as Java, Smalltalk, C++ or the like and conventional procedural programming languages, such as the “C” programming language or similar programming languages.

Illustrated processing block 28 provides for generating a schedule for a plurality of tasks. As already noted, the schedule may be automatically generated based on one or more of contextual information, constraint information, or preference information related to the plurality of tasks. Moreover, the schedule may include a plurality of individual-specific task lists, and generating the schedule may include determining location data with respect to a plurality of individuals responsible for completing the plurality of tasks, interpreting message data, and so forth. At least a portion of the schedule may be communicated at block 30 to one or more individuals responsible for completing at least one of the plurality of tasks. Communicating at least the portion of the schedule may include transmitting a message (e.g., email, text, IM, SMS message, alert or similar messaging mechanism), modifying a calendar, and so forth.

A determination may be made at block 32 as to whether a real-time change has occurred in one or more of the contextual information, the constraint information or the preference information. If so, the schedule may be automatically revised at block 28 in response to the real-time change. Revising the schedule may include revising an order of the schedule, adding a task to the schedule, removing a task from the schedule, and so forth.

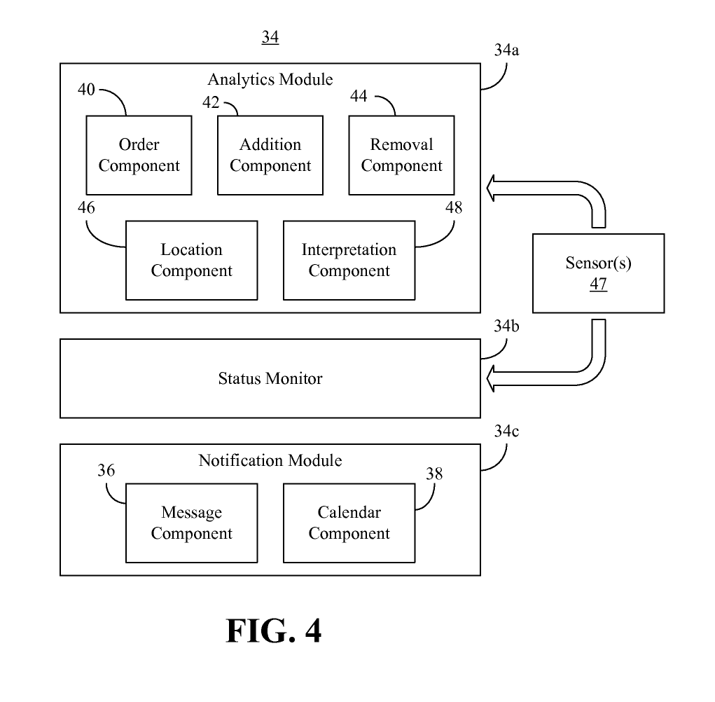

FIG. 4 shows a logic architecture 34 (34a-34c) that may be used to optimize schedules. The logic architecture 34 may therefore implement one or more aspects of the method 26 (FIG. 3) and may be readily substituted for the optimization system 10 (FIG. 1), already discussed. In the illustrated example, an analytics module 34a may generate a schedule for a plurality of tasks based on one or more of contextual information, constraint information or preference information related to the plurality of tasks, wherein the schedule is to include a plurality of individual-specific task lists. In addition, a status monitor 34b may detect a real-time change in one or more of the contextual information, the constraint information or the preference information, wherein the analytics module 34a may revise the schedule in response to the real-time change.

The illustrated architecture 34 also includes a notification module 34c to communicate at least a portion of the revised schedule to one or more individuals responsible for completing at least one of the plurality of tasks. In one example, the notification module 34c includes a message component 36 that transmits a message (via on screen message, email, text message, SMS message, LED, audible tone, or similar messaging mechanisms) regarding the revised schedule to the one or more individuals. The notification module 34c may also include a calendar component 38 to modify a calendar of the one or more individuals.

The analytics module 34a may also include an order component 40 to revise an order of the schedule, an addition component 42 to add a task to the schedule and/or a removal component 44 to remove a task from the schedule. The components 40, 42, 44 may operate on the entire schedule or on one or more of the individual-specific task lists, depending upon the circumstances. Thus, removal of a task from one task list may be accompanied by adding that task to another task list, and/or vice versa. Moreover, the components 40, 42, 44 may be part of a single process or logic unit, separate processes/logic units, etc., or any combination thereof. Additionally, the components 40, 42, 44 may operate/run sequentially, serially, in parallel, etc., depending upon the circumstances.

As already noted, the contextual information may include location data, message data, calendar, etc. In this regard, the analytics module 34a may include a location component 46 to determine the location data with respect to a plurality of individuals responsible for completing the plurality of tasks. Additionally, the analytics module 34a may include an interpretation component 48 to interpret the message data. The constraint information may include one or more weather constraints, time constraints, personnel constraints, vehicle constraints or traffic constraints, etc., and the preference information may include one or more personnel preferences, vehicle preferences, time preferences, etc. In this regard, the architecture 34 may also include other components (not shown) such as, for example, a weather component to determine the current and/or predicted weather, a traffic component to determine the current and/or predicted traffic patterns, and so forth.

In one example, one or more sensors 47 provide at least a portion of the contextual information, constraint information and/or preference information to the analytics module 34a and/or status monitor 34b. The sensors 47, which may be distributed across multiple client devices, resident in a cloud computing infrastructure, etc., or any combination thereof, may include hardware sensors (e.g., GPS sensors), software sensors (e.g., web sensors, cloud sensors, social network sensors), etc., or any combination thereof.

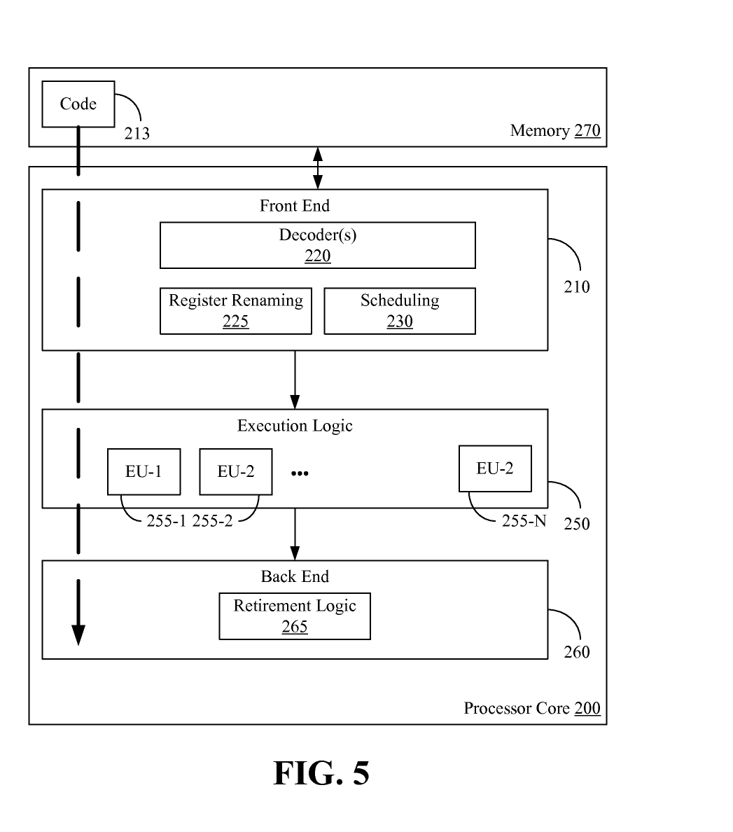

FIG. 5 illustrates a processor core 200 according to one embodiment. The processor core 200 may be the core for any type of processor, such as a micro-processor, an embedded processor, a digital signal processor (DSP), a network processor, or other device to execute code. Although only one processor core 200 is illustrated in FIG. 5, a processing element may alternatively include more than one of the processor core 200 illustrated in FIG. 5. The processor core 200 may be a single-threaded core or, for at least one embodiment, the processor core 200 may be multithreaded in that it may include more than one hardware thread context (or “logical processor”) per core.

FIG. 5 also illustrates a memory 270 coupled to the processor core 200. The memory 270 may be any of a wide variety of memories (including various layers of memory hierarchy) as are known or otherwise available to those of skill in the art. The memory 270 may include one or more code 213 instruction(s) to be executed by the processor core 200, wherein the code 213 may implement the method 26 (FIG. 3), already discussed. The processor core 200 follows a program sequence of instructions indicated by the code 213. Each instruction may enter a front end portion 210 and be processed by one or more decoders 220. The decoder 220 may generate as its output a micro operation such as a fixed width micro operation in a predefined format, or may generate other instructions, microinstructions, or control signals which reflect the original code instruction. The illustrated front end 210 also includes register renaming logic 225 and scheduling logic 230, which generally allocate resources and queue the operation corresponding to the convert instruction for execution.

The processor core 200 is shown including execution logic 250 having a set of execution units 255-1 through 255-N. Some embodiments may include a number of execution units dedicated to specific functions or sets of functions. Other embodiments may include only one execution unit or one execution unit that can perform a particular function. The illustrated execution logic 250 performs the operations specified by code instructions.

After completion of execution of the operations specified by the code instructions, back end logic 260 retires the instructions of the code 213. In one embodiment, the processor core 200 allows out of order execution but requires in order retirement of instructions. Retirement logic 265 may take a variety of forms as known to those of skill in the art (e.g., re-order buffers or the like). In this manner, the processor core 200 is transformed during execution of the code 213, at least in terms of the output generated by the decoder, the hardware registers and tables utilized by the register renaming logic 225, and any registers (not shown) modified by the execution logic 250.

Although not illustrated in FIG. 5, a processing element may include other elements on chip with the processor core 200. For example, a processing element may include memory control logic along with the processor core 200. The processing element may include I/O control logic and/or may include I/O control logic integrated with memory control logic. The processing element may also include one or more caches.

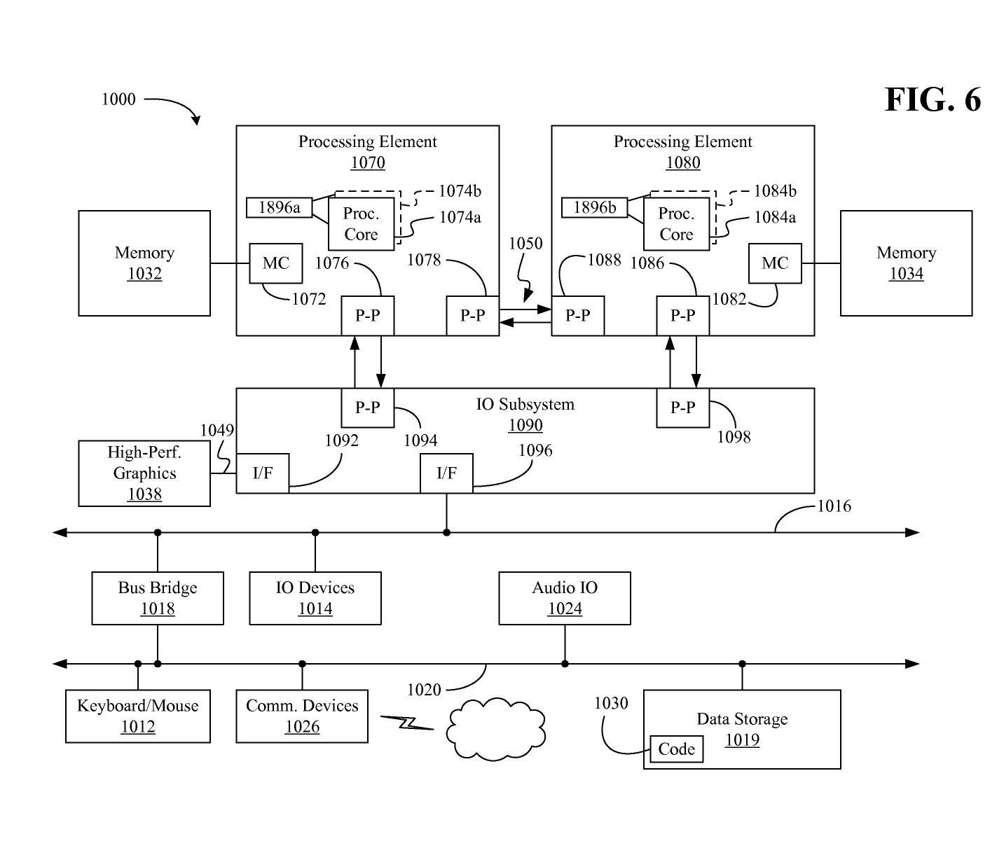

Referring now to FIG. 6, shown is a block diagram of a system 1000 embodiment in accordance with an embodiment. Shown in FIG. 6 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 6 may be implemented as a multi-drop bus rather than point-to-point interconnect.

As shown in FIG. 6, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 5.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 6, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 6, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 6, various I/O devices 1014 (e.g., cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, network controllers/communication device(s) 1026 (which may in turn be in communication with a computer network), and a data storage unit 1019 such as a disk drive or other mass storage device which may include code 1030, in one embodiment. The code 1030 may include instructions for performing embodiments of one or more of the methods described above. Thus, the illustrated code 1030 may implement the method 26 (FIG. 3), already discussed, and may be similar to the code 213 (FIG. 5), already discussed. Further, an audio I/O 1024 may be coupled to second bus 1020.

Note that other embodiments are contemplated. For example, instead of the point-to-point architecture of FIG. 6, a system may implement a multi-drop bus or another such communication topology. Also, the elements of FIG. 6 may alternatively be partitioned using more or fewer integrated chips than shown in FIG. 6.

### Additional Notes and Examples

Example 1 may include an apparatus to optimize schedules, comprising an analytics module to generate a schedule for a plurality of tasks based on one or more of contextual information, constraint information or preference information related to the plurality of tasks, wherein the schedule is to include a plurality of individual-specific task lists. The apparatus may also include a status monitor to detect a real-time change in one or more of the contextual information, the constraint information or the preference information, wherein the analytics module is to automatically revise the schedule in response to the real-time change.

Example 2 may include the apparatus of Example 1, further including a notification module to communicate at least a portion of the revised schedule to one or more individuals responsible for completing at least one of the plurality of tasks.

Example 3 may include the apparatus of Example 2, wherein the notification module includes one or more of a message component to transmit a message or a calendar component to modify a calendar.

Example 4 may include the apparatus of Example 1, wherein the analytics module includes one or more of an order component to revise an order of the schedule, an addition component to add a task to the schedule or a removal component to remove a task from the schedule.

Example 5 may include the apparatus of Example 1, wherein the status monitor is to obtain the contextual information from one or more of a client device, a centralized repository, one or more sensors, user preferences, public information or private information, and the contextual information is to include one or more of current status data, location data, message data or calendar data associated with one or more individuals.

Example 6 may include the apparatus of Example 5, wherein the analytics module includes one or more of a location component to determine the location data with respect to a plurality of individuals responsible for completing the plurality of tasks or an interpretation component to interpret the message data.

Example 7 may include the apparatus of any one of Examples 1 to 6, wherein the constraint information is to include one or more weather constraints, time constraints, personnel constraints, vehicle constraints or traffic constraints.

Example 8 may include the apparatus of any one of Examples 1 to 6, wherein the preference information is to include one or more personnel preferences, vehicle preferences, store preferences or time preferences.

Example 9 may include a method of optimizing schedules, comprising generating a schedule for a plurality of tasks based on one or more of contextual information, constraint information or preference information related to the plurality of tasks, wherein the schedule includes a plurality of individual-specific task lists, detecting a real-time change in one or more of the contextual information, the constraint information or the preference information, and automatically revising the schedule in response to the real-time change.

Example 10 may include the method of Example 9, further including communicating at least a portion of the revised schedule to one or more individuals responsible for completing at least one of the plurality of tasks.

Example 11 may include the method of Example 10, wherein communicating at least the portion of the revised schedule includes one or more of transmitting a message or modifying a calendar.

Example 12 may include the method of Example 9, wherein automatically revising the schedule includes one or more of revising an order of the schedule, adding a task to the schedule or removing a task from the schedule.

Example 13 may include the method of Example 9, further including obtaining the contextual information from one or more of a client device, a centralized repository, one or more sensors, user preferences, public information or private information, wherein the contextual information includes one or more of current status data, location data, message data or calendar data associated with one or more individuals.

Example 14 may include the method of Example 13, wherein generating the schedule includes one or more of determining the location data with respect to a plurality of individuals responsible for completing the plurality of tasks or interpreting the message data.

Example 15 may include the method of any one of Examples 9 to 14, wherein the constraint information includes one or more weather constraints, time constraints, personnel constraints, vehicle constraints or traffic constraints.

Example 16 may include the method of any one of Examples 9 to 14, wherein the preference information includes one or more personnel preferences, vehicle preferences, store preferences or time preferences.

Example 17 may include the method of Example 9, further including obtaining the contextual information from one or more of a device associated with an individual responsible for completing at least one of the plurality of tasks or a cloud computing infrastructure.

Example 18 may include at least one computer readable storage medium comprising a set of instructions which, when executed by a computing device, cause the computing device to generate a schedule for a plurality of tasks based on one or more of contextual information, constraint information or preference information related to the plurality of tasks. The instructions, when executed, may also cause a computing device to detect a real-time change in one or more of the contextual information, the constraint information or the preference information, and automatically revise the schedule in response to the real-time change.

Example 19 may include the at least one computer readable storage medium of Example 18, wherein the instructions, when executed, cause a computing device to communicate at least a portion of the revised schedule to one or more individuals responsible for completing the plurality of tasks.

Example 20 may include the at least one computer readable storage medium of Example 19, wherein the instructions, when executed, cause a computing device to one or more of transmit a message or modify a calendar to communicate at least the portion of the revised schedule.

Example 21 may include the at least one computer readable storage medium of Example 18, wherein the instructions, when executed, cause a computing device to one or more of revise an order of the schedule, add a task to the schedule or remove a task from the schedule to revise the schedule.

Example 22 may include the at least one computer readable storage medium of Example 18, wherein the instructions, when executed, cause a computing device to obtain the contextual information from one or more of a client device, a centralized repository, one or more sensors, user preferences, public information or private information, and wherein the contextual information is to include one or more of current status data, location data, message data or calendar data associated with one or more individuals.

Example 23 may include the at least one computer readable storage medium of Example 22, wherein the instructions, when executed, cause a computing device to one or more of determine the location data with respect to a plurality of individuals responsible for completing the plurality of tasks or interpret the message data to generate the schedule.

Example 24 may include the at least one computer readable storage medium of any one of Examples 18 to 23, wherein the constraint information is to include one or more weather constraints, time constraints, personnel constraints, vehicle constraints or traffic constraints.

Example 25 may include the at least one computer readable storage medium of any one of Examples 18 to 23, wherein the preference information is to include one or more personnel preferences, vehicle preferences, store preferences or time preferences.

Example 26 may include an apparatus to optimize schedules, comprising means for generating a schedule for a plurality of tasks based on one or more of contextual information, constraint information or preference information related to the plurality of tasks, wherein the schedule includes a plurality of individual-specific task lists, means for detecting a real-time change in one or more of the contextual information, the constraint information or the preference information, and means for automatically revising the schedule in response to the real-time change.

Example 27 may include the apparatus of Example 26, further including communicating at least a portion of the revised schedule to one or more individuals responsible for completing the plurality of tasks.

Example 28 may include the apparatus of Example 27, wherein communicating at least the portion of the revised schedule includes one or more of transmitting a message or modifying a calendar.

Example 29 may include the apparatus of Example 26, wherein automatically revising the schedule includes one or more of revising an order of the schedule, adding a task to the schedule or removing a task from the schedule.

Example 30 may include the apparatus of Example 26, further including means for obtaining the contextual information from one or more of a client device, a centralized repository, one or more sensors, user preferences, public information or private information, wherein the contextual information includes one or more of location data, message data or calendar data.

Example 31 may include the apparatus of Example 30, wherein generating the schedule includes one or more of determining the location data with respect to a plurality of individuals responsible for completing the plurality of tasks or interpreting the message data.

Example 32 may include the apparatus of any one of Examples 26 to 31, wherein the constraint information is to include one or more weather constraints, time constraints, personnel constraints, vehicle constraints or traffic constraints.

Example 33 may include the apparatus of any one of Examples 26 to 31, wherein the preference information is to include one or more personnel preferences, vehicle preferences or time preferences.

Example 34 may include an apparatus to optimize schedules, comprising means for performing the method of any combination of Examples 9 to 17.

Thus, techniques described herein may optimize an individual's or group's actions to achieve a set of individual or shared activities/tasks. The techniques may accept as input 1) tasks to achieve, 2) resources and their preferences/constraints (individual, schedules, vehicle availability, etc.), 3) contextual information from the environment (e.g., store openings/closings, dynamic constraints such as traffic, etc.) and 4) current status of individuals, users and/or members. Given these inputs, an optimized schedule may be generated that meets the constraints and preferences to both pre-plan activities and react in real-time to the realities of ever-changing priorities and the environment. This information may be provided to the devices (e.g., smart phone, tablet, wearable device, in-vehicle connected devices) of the individuals in the group so that they may be kept aware of the changing circumstances of the group as a whole. The techniques may make use of underlying functionality such as scheduling, calendaring, geo-location sensing, data correlation, recommendation, intuitive user interfaces, social media sites, and real-time reporting.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus comprising:
an analytics module to generate a schedule for a plurality of tasks based on one or more of contextual information, constraint information or preference information related to the plurality of tasks, wherein the schedule is to include a plurality of individual-specific task lists; and
a status monitor to detect a real-time change in one or more of the contextual information, the constraint information or the preference information, wherein the analytics module is to automatically revise the schedule in response to the real-time change.

2. The apparatus of claim 1, further including a notification module to communicate at least a portion of the revised schedule to one or more individuals responsible for completing at least one of the plurality of tasks.

3. The apparatus of claim 2, wherein the notification module includes one or more of a message component to transmit a message or a calendar component to modify a calendar.

4. The apparatus of claim 1, wherein the analytics module includes one or more of an order component to revise an order of the schedule, an addition component to add a task to the schedule or a removal component to remove a task from the schedule.

5. The apparatus of claim 1, wherein the status monitor is to obtain the contextual information from one or more of a client device, a centralized repository, one or more sensors, user preferences, public information or private information, and the contextual information is to include one or more of current status data, location data, message data or calendar data associated with one or more individuals.

6. The apparatus of claim 5, wherein the analytics module includes one or more of a location component to determine the location data with respect to a plurality of individuals responsible for completing the plurality of tasks or an interpretation component to interpret the message data.

7. The apparatus of claim 1, wherein the constraint information is to include one or more weather constraints, time constraints, personnel constraints, vehicle constraints or traffic constraints.

8. The apparatus of claim 1, wherein the preference information is to include one or more personnel preferences, vehicle preferences, store preferences or time preferences.

9. A method comprising:
generating a schedule for a plurality of tasks based on one or more of contextual information, constraint information or preference information related to the plurality of tasks, wherein the schedule includes a plurality of individual-specific task lists;
detecting a real-time change in one or more of the contextual information, the constraint information or the preference information; and
automatically revising the schedule in response to the real-time change.

10. The method of claim 9, further including communicating at least a portion of the revised schedule to one or more individuals responsible for completing at least one of the plurality of tasks.

11. The method of claim 10, wherein communicating at least the portion of the revised schedule includes one or more of transmitting a message or modifying a calendar.

12. The method of claim 9, wherein automatically revising the schedule includes one or more of revising an order of the schedule, adding a task to the schedule or removing a task from the schedule.

13. The method of claim 9, further including obtaining the contextual information from one or more of a client device, a centralized repository, one or more sensors, user preferences, public information or private information, wherein the contextual information includes one or more of current status data, location data, message data or calendar data associated with one or more individuals.

14. The method of claim 13, wherein generating the schedule includes one or more of determining the location data with respect to a plurality of individuals responsible for completing the plurality of tasks or interpreting the message data.

15. The method of claim 9, wherein the constraint information includes one or more weather constraints, time constraints, personnel constraints, vehicle constraints or traffic constraints.

16. The method of claim 9, wherein the preference information includes one or more personnel preferences, vehicle preferences, store preferences or time preferences.

17. The method of claim 9, further including obtaining the contextual information from one or more of a device associated with an individual responsible for completing at least one of the plurality of tasks or a cloud computing infrastructure.

18. At least one computer readable storage medium comprising a set of instructions which, when executed by a computing device, cause the computing device to:
generate a schedule for a plurality of tasks based on one or more of contextual information, constraint information or preference information related to the plurality of tasks, wherein the schedule is to include a plurality of individual-specific task lists;
detect a real-time change in one or more of the contextual information, the constraint information or the preference information; and
automatically revise the schedule in response to the real-time change.

19. The at least one computer readable storage medium of claim 18, wherein the instructions, when executed, cause a computing device to communicate at least a portion of the revised schedule to one or more individuals responsible for completing at least one of the plurality of tasks.

20. The at least one computer readable storage medium of claim 19, wherein the instructions, when executed, cause a computing device to one or more of transmit a message or modify a calendar to communicate at least the portion of the revised schedule.

21. The at least one computer readable storage medium of claim 18, wherein the instructions, when executed, cause a computing device to one or more of revise an order of the schedule, add a task to the schedule or remove a task from the schedule to revise the schedule.

22. The at least one computer readable storage medium of claim 18, wherein the instructions, when executed, cause a computing device to obtain the contextual information from one or more of a client device, a centralized repository, one or more sensors, user preferences, public information or private information, and wherein the contextual information is to include one or more of current status data, location data, message data or calendar data associated with one or more individuals.

23. The at least one computer readable storage medium of claim 22, wherein the instructions, when executed, cause a computing device to one or more of determine the location data with respect to a plurality of individuals responsible for completing the plurality of tasks or interpret the message data to generate the schedule.

24. The at least one computer readable storage medium of claim 18, wherein the constraint information is to include one or more weather constraints, time constraints, personnel constraints, vehicle constraints or traffic constraints.

25. The at least one computer readable storage medium of claim 18, wherein the preference information is to include one or more personnel preferences, vehicle preferences, store preferences or time preferences.
